(19) United States
(12) Patent Application Publication
(10) Pub. No.: US 2008/0308374 A1
(43) Pub. Date: Dec. 18, 2008

(54) Hydrodynamic torque converter having a bypass clutch

(76) Inventors: Kai Heukelbach, Stuttgart (DE); Bernd Koppitz, Winterbach (DE); Heinz Schultz, Hochdorf (DE); Bernhard Ziegler, Rechberghausen (DE)

Correspondence Address: KLAUS J. BACH, 4407 TWIN OAKS DRIVE, MURRYSVILLE, PA, 15668, US

(21) Appl. No.: 12/150,349

(22) Filed: Apr. 25, 2008

Related U.S. Application Data
(63) Continuation-in-part of application No. PCT/EP2006/009846, filed on Oct. 12, 2006.

(30) Foreign Application Priority Data
Oct. 28, 2005 (DE) 10 2005 051 739.0

(51) Int. Cl. F16D 33/00

(52) U.S. Cl. 192/3.25

(57) ABSTRACT

In a hydrodynamic torque converter having a long-life torque converter lock-up or bypass clutch with an axial piston structure for engaging the clutch plates of the clutch and fluid flow control structures are provided for supplying a controlled flow of lubricant to the clutch plates via the axial piston cylinder structure for lubricating and cooling the clutch plates and a torsion damper is provided adjacent the clutch and effective to reduce the transmission of torque oscillations to the vehicle transmission.

This is a Continuation-In-Part Application of pending International patent application PCT/EP2006/009846 filed Oct. 12, 2006 and claiming the priority of German patent application 10 2005 051 739.0 filed Oct. 28, 2005.

### BACKGROUND OF THE INVENTION

The invention relates to a hydrodynamic torque converter having a torque converter bypass clutch with clutch plates which are engageable by an axial piston.

DE 102 33 335 A1 discloses a hydrodynamic torque converter having a torque converter bypass or lock-up clutch. The bypass clutch has clutch plates which can be engaged by an axial piston. For cooling the plates of the bypass clutch, a targeted amount of leakage oil is conducted from a piston space of the bypass clutch to the clutch plates by way of bores.

Furthermore, DE 198 26 351 C2 discloses a hydrodynamic torque converter having a bypass clutch and two torsion dampers.

It is an object of the invention to provide a hydrodynamic torque converter with a lock-up or bypass clutch, via which the power transfer path through the transmission can by-pass the torque converter and which provides for a constant performance over a very long service life.

### SUMMARY OF THE INVENTION

In a hydrodynamic torque converter having a long-life torque converter lock-up or bypass clutch with an axial piston structure for engaging the clutch plates of the clutch and fluid flow, control structures are provided for supplying a controlled flow of lubricant to the clutch plates via the axial piston cylinder structure for lubricating and cooling the clutch plates and a torsion damper is provided adjacent the clutch and effective to reduce the transmission of torque oscillations to the vehicle transmission.

In this way, a highly effective cooling procedure is provided which protects the clutch from thermal overloading. The cooling procedure consists in a targeted conduction of the hydraulic fluid through the pressure space for an axial piston for operating the bypass clutch. The hydraulic fluid is subsequently guided along the clutch plates into a converter interior space in which a torsion damper is accommodated for transmitting the engine torque from the by-pass clutch to the transmission. The torsion damper makes it possible to provide the bypass clutch with a very low degree of clutch slip in the engaged state. Here, the clutch slip differential rotational speed is superposed on the torsional vibrations at the torsion damper. The superposing friction at the clutch plates assists the damping action at the spring-damper system of the torsion damper, which is formed by the resilient component and the frictionally engaging component, which acts under centrifugal force, of disc pressure springs. Here, the slip differential rotational speed of the bypass clutch can be selected to be very low—in the extreme case down to virtually zero—since the torsion damper already isolates a large part of the rotational speed irregularities of the drive engine from the transmission input shaft. As a result of the reduced clutch slip differential rotational speed in relation to torque converters without torsion dampers, the friction and therefore the wear and the thermal loading at the clutch plates is additionally reduced by means of the measure mentioned in the introduction. The reduction in wear obtained by means of the invention makes it possible for the control of the clutch disengagement to perform with high accuracy and over a long service life since wear is virtually non-existent and therefore negligible for the control of the bypass clutch.

The bypass clutch can particularly advantageously be closed so as to permit a low degree of slip even at very low hydraulic fluid temperatures in winter—for example even below 10° C. since as a result of the lubrication/cooling according to the invention, relatively constant friction conditions prevail between the clutch plates, so that the torsional vibration damping of the torsion damper alone is sufficient to decouple the rotational speed irregularities of the drive engine.

A low variation of the damper characteristic values is also particularly advantageously obtained, since the hydraulic fluid is heated up more quickly at the bypass clutch which is engaged and disengaged and operated partially in a slip mode.

The bypass clutch can particularly advantageously have more than two clutch plates, so that the loading is distributed among a high number of clutch plates for a further increase in durability. The clutch plates comprise outer and inner clutch plates.

A groove pattern in the clutch plates can particularly advantageously assist the flow of the hydraulic fluid past the clutch plates.

As a result of the low level of wear, it is particularly advantageously possible, despite high input torques, for the bypass clutch to be designed as a multiplate clutch which is arranged on a separate carrier lamella at a diameter which is radially relatively far inward. Although the small diameter is inevitably associated with a small surface of the clutch plates, as a result of the design according to the invention, said small surface is however not subjected to excessive loading.

The invention will become more readily apparent from the following description of exemplary embodiments thereof on the basis of the accompanying drawings:

### BRIEF DESCRIPTION OF THE DRAWINGS

FIG. 1 shows a drive arrangement having a hydrodynamic torque converter, a bypass clutch and a torsion damper,

FIG. 2 shows a detail in the region of the bypass clutch from FIG. 1, which shows a plate carrier and clutch plates,

FIG. 3 shows, in an alternative embodiment, a shaft-hub connection of the plate carrier to outer clutch plates,

FIG. 4 shows, in a first view, an axial piston of the by-pass clutch which is sealed off with respect to the plate carrier by means of a sealing ring which has a recess providing for a defined leakage,

FIG. 5 shows, in a second view, the sealing ring from FIG. 4,

FIG. 6 shows an alternative embodiment of a sealing ring which acts as a non-return valve and which is illustrated in a flow-transmitting state,

FIG. 7 shows the sealing ring as per FIG. 6 in a blocking state,

FIG. 8 shows an alternative embodiment of an axial piston with a separate non-return valve,

FIG. 9 shows, in a first view, a slotted axial piston, and

FIG. 10 shows, in a second view, the axial piston from FIG. 9.

### DESCRIPTION OF PARTICULAR EMBODIMENT

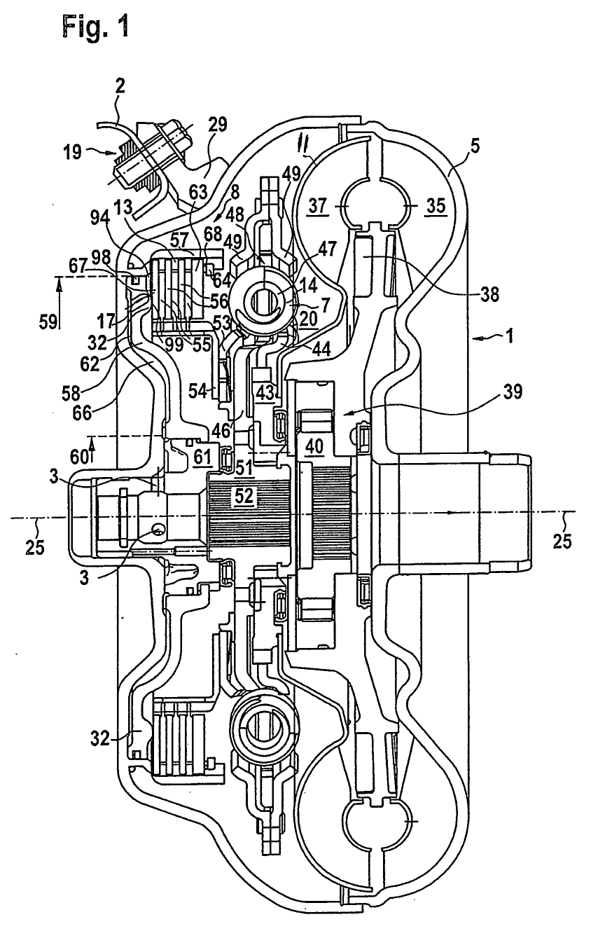

FIG. 1 shows a drive arrangement having a hydrodynamic torque converter 1 which is rotationally fixedly connected at the input side by means of an oblique screw connection 19 to a partially flexible driver disk 2. Such an obliquely bolted-on driver disk 2 is illustrated in more detail for example in patent documents EP 1347210 B1 and DE 102004050772.4. Said driver disk 2 may be partially flexible and is mounted to a crankshaft (not illustrated in any more detail) of a drive engine, so that the constant rocking motion of the crankshaft as a result of the individual explosions in the charged combustion chambers are to some extent compensated.

At the output side, the hydrodynamic torque converter is connected by means of a spline toothing 52 to a coaxially arranged transmission input shaft (not illustrated in any more detail) of a transmission. The transmission input shaft, the hydrodynamic torque converter and a crankshaft flange are arranged here coaxially with respect to a central axis 25.

The hydrodynamic torque converter 1 comprises the housing 5, a pump wheel 35, a turbine wheel 37 and a guide wheel 38.

Here, the following more detailed description of the exemplary embodiment follows the force flow from the crankshaft to the transmission input shaft. The force flow extends here from the crankshaft via the driver disk 14, and via a connecting part 29 which is clamped to the driver disk 2 by means of the oblique screw connection 19 so as to be fixed in terms of movement, to the housing 5 which is welded to the connecting part 29. From the housing 5, the force flow reaches the pump wheel 35. During a hydrodynamic trans-mission of torque, the force flow is transmitted from the pump wheel 35 to the turbine wheel 37 and via a torsion damper 7 to the transmission input shaft. In contrast, when a bypass clutch 8 is engaged, the force flow is transmitted from the housing 5 via the bypass clutch 8 to the damper 7 and subsequently to the transmission input shaft.

A region 11, which is cup-shaped at the side of the drive engine, of the housing 5 of the hydrodynamic torque converter. 1 is mounted in a spherical roller bearing (not illustrated) coaxially, so as to be rotatable, with respect to the crankshaft.

The turbine wheel 37 is arranged on that side of the pump wheel 35 which faces toward the drive engine. Arranged axially between the pump wheel 35 and the turbine wheel 37 is the guide wheel 38 which is supported in a conventional manner on a freewheel structure 39.

An inner hub 40 of the freewheel structure 39 is rotationally fixedly connected by means of an internal toothing to a stator shaft (not illustrated).

The turbine wheel 37 is rotationally fixedly connected by means of a carrier ring 43 to a spring carrier 44 which is arranged so as to be rotatable to a limited extent, counter to the torsional stiffness of the damper 7, with respect to a support lamella 46. For this purpose, bow springs 47, 14 of the damper 7 are held in recesses 48 which are formed in the lamella
of the support lamella 46,
of the spring carrier 44 and
of a clutch lamella 53 which is rotationally fixedly riveted to said spring carrier 44.

The spring carrier 44 is connected fixedly in terms of movement to the clutch lamella 53.

The support lamella 46 is provided radially outside the curved springs 47, 14 in the peripheral direction with curved extensions 49 which guide the bow springs 14. The support lamella 46 is rotationally fixedly connected radially at the inside to a bush 51. Said bush 51 is rotationally fixedly connected by means of the spline toothing 52 mentioned in the introduction to the transmission input shaft.

The clutch lamella 53 is connected fixedly in terms of movement to an inner plate carrier 54. The inner plate carrier 54 retains inner clutch plates 55 of the bypass clutch 8 in a rotationally fixed and axially movable manner by means of an axial toothing. Outer clutch plates 56, 67 are likewise retained in a rotationally fixed and axially movable manner on an outer plate carrier 57 which is fixedly connected to the housing 5. For this purpose, an axially aligned internal toothing 13 is formed in the outer plate carrier 57, into which internal toothing 13 an external toothing of the outer clutch plates 56, 67 engages. The outer plate carrier 57 extends coaxially with respect to the housing 5 and is friction-welded thereto so as to be fixed in terms of movement. The outer and the inner clutch plates 56, 67, 55 are radially interleafed with another.

An axial piston 58 is guided axially at its periphery 59 in the outer plate carrier 57 and at its central bore 60 on a journal 61. Said journal 61 is calked fixedly in terms of movement to the housing 5. The bypass clutch 8 can be engaged by means of the axial piston 58 which can be hydraulically pressurized on its outer side 62. For this purpose, an annular axial projection 32 arranged on the axial piston 58 bears sealingly against the outermost clutch plate 67 of the outer clutch plates 56, so that a sealing face 99 is formed. When the axial piston 58 is disengaged and the bypass clutch 8 is engaged, the clutch plates 55, 67, 56 which are connected to one another in a frictionally engaging manner are supported via a thrust bearing disk 63 on a securing ring 64. Said securing ring 64 is latched into an inner peripheral groove of the outer plate carrier 57. Here, a sealing ring 68 is arranged between the thrust bearing disk 63 and the securing ring 64, so that a hydraulic fluid which acts under pressure in the space widths of the internal toothing 13 cannot pass through a gap between the thrust bearing disk 63 and the securing ring 64.

The housing 5, the outer side 62 of the axial piston 58, the outer plate carrier 57 and the journal 61 enclose a pressure space 66 which can be filled with hydraulic fluid. For the supply with pressurized hydraulic fluid, the hollow-bored journal 61 has a plurality of transverse bores 3 in its wall, which transverse bores 3 are connected (in a way not illustrated in any more detail) by means of a central longitudinal bore in the transmission input shaft to a valve which is controlled by a transmission controller. When the valve is opened, the hydraulic fluid flows under pressure via the longitudinal bore and the transverse bores 3 to the pressure space 65 so as to actuate the axial piston 58, and engage the clutch plates 55, 56 with one another frictionally with a force corresponding to the hydraulic pressure, to transmit a torque from the housing 5 to the torsion damper 7.

An obliquely extending throttle bore 17 is arranged radially in the region of the annular projection 32, which throttle bore 17 provides for limited communication between the pressure space 66 and the space between the teeth of the internal toothing 13. For this purpose, the throttle bore 17 opens out radially outside the annular projection 32. Accordingly, hydraulic fluid passes through the throttle bore 17 once the pressure within the pressure space 66 is greater than in the space in which the torsion damper 7 is disposed. The hydraulic fluid which passes through the throttle bore 17 flows along the outermost clutch plate 67 and along said space widths. Since a pressure dissipation at the end of the clutch plates 56, 57 or the thrust bearing disk 63 is pre-vented by the sealing ring 68, the oil flow is distributed between the gaps between the outer and inner clutch plates 67, 56, 55. Here, the clutch lining of the clutch plates 56, 55 has a groove pattern which conducts the hydraulic fluid radially inward. From the gaps, the hydraulic fluid accordingly flows into a converter interior space in which the torsion damper 7 is also arranged.

There is an indentation 20 between the turbine wheel 37 and the freewheel 39 which is arranged radially within the turbine wheel 37 in the same axial region. The curved springs 47, 14 of the torsion damper 7 project into said indentation 20, since the curved springs 47, 14 are situated at the same radial distance from the central axis 25. Axially adjacent thereto, the clutch plates 67, 55, 56 are disposed likewise at the same radial distance from the central axis 25. An installation space is therefore formed outside the housing 5 radially outside the clutch plates 67, 55, 56, which installation space is taken up by the connecting part 29 mentioned in the introduction. The connecting part, from the outer diameter, therefore does not go beyond the outer diameter of the housing 5 in the region of the pump wheel 35 and the turbine wheel 37. Said arrangement of the components with respect to one another ensures small axial and radial dimensions with easy access to the screw connection 19 of the hydrodynamic torque converter 1 to the driver disk 2.

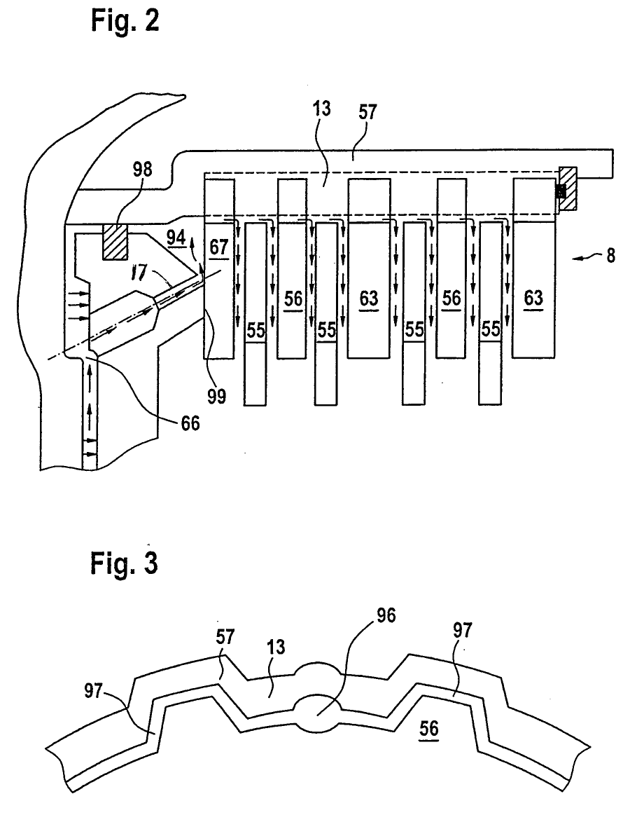

FIG. 2 shows a detail from FIG. 1, which shows the bypass clutch 8. Here, arrows indicate how the hydraulic fluid is pushed out of the pressure space 66 through a large bore and subsequently the defined throttle bore 17. From there, the hydraulic fluid is pressed into a space 94 which is sealed off by the sealing face 99 and an axial piston sealing ring 98, so that the hydraulic fluid which is under pressure there escapes into the space widths 97 illustrated in FIG. 3. From there, the hydraulic fluid is distributed between the clutch plates 67, 55, 56, with the groove pattern in the clutch plate linings directing the fluid flow radially inward, counter to the centrifugal force.

Depending on how wide the space widths are, it is possible for an additional oil throughflow recess 96 to be provided. Said additional oil throughflow recess 96 can be formed, corresponding to FIG. 3, both in the plate carrier 57 and also in the clutch plates 56. Alternatively, the oil throughflow recess 96 can also be formed only in one of the two components.

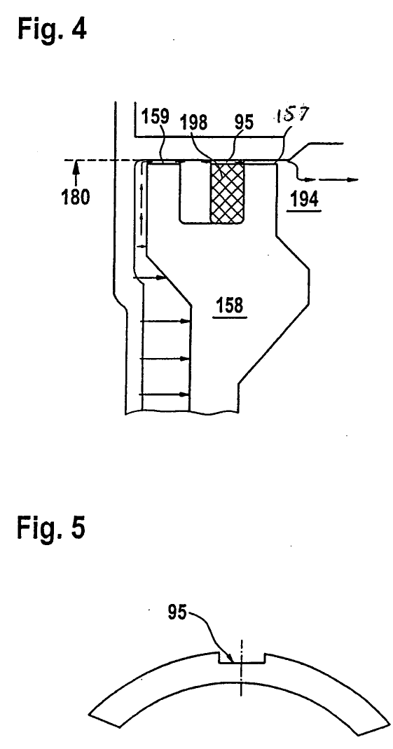

In the alternative embodiment as per FIG. 4 and FIG. 5, an axial piston sealing ring 198 for producing a defined leakage can also have a plurality of recesses 95 distributed about the outer periphery, which recesses 95 extend parallel to the central axis 25. Here, the axial piston 158 has, radially at the outside, a clearance fit with respect to its guide recess 180 in the plate carrier 157, which clearance fit permits, over the entire periphery 159, a defined throughflow of hydraulic fluid to the recess 95 of the axial piston sealing ring 198. After flowing through the recess 95, the hydraulic fluid flows again over the entire periphery 159, into a space 194 from which the hydraulic fluid is distributed, corresponding to FIG. 1 and FIG. 2, between the clutch plates.

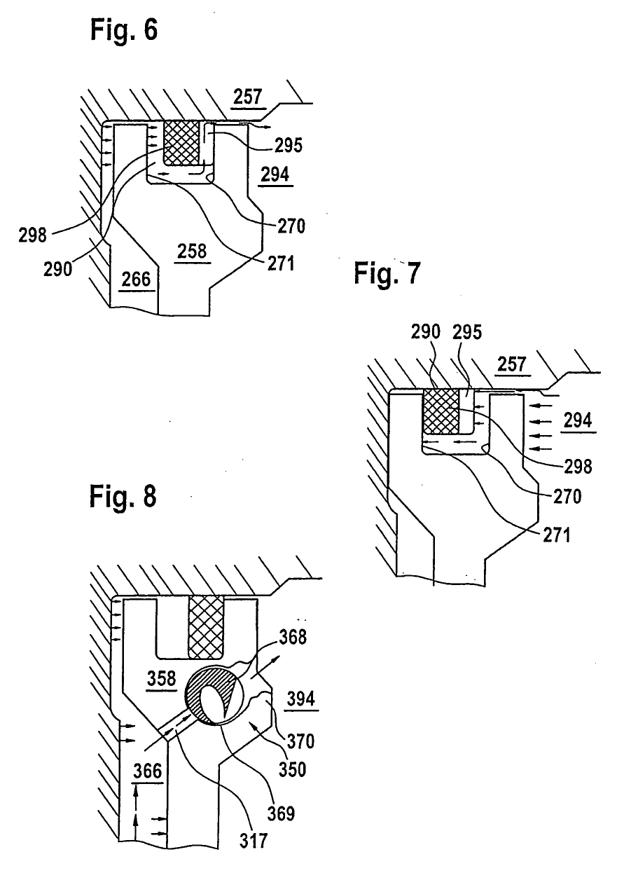

FIG. 6 shows, in a further alternative embodiment, one possibility for producing the targeted leakage. Here, the axial piston sealing ring 298 has radially outwardly directed grooves 295. Said grooves 295 are arranged on that end side of the axial piston sealing ring 298 which faces away from the pressure space 266. The axial piston sealing ring 298 also has, with respect to its receiving groove 290 in the axial piston 258,
a radially inner play and
an axial play with respect to the central axis 25.

If a greater pressure now prevails in the pressure space 266 than in the space 294 because the axial piston 258 is presently disengaged or because said axial piston 258 is holding the bypass clutch closed, then the axial piston sealing ring 298 bears with its grooved side against the inner wall 270 of the holding groove 290. The hydraulic fluid accordingly flows:
from the pressure space 266,
along the clearance fit of the piston 258 with respect to the plate carrier 257,
along the axial play of the axial sealing ring 298 with respect to the axial piston 258,
along the inner radial play of the axial piston sealing ring 298 with respect to the axial piston 258,
through the radial grooves 295,
along the axial play of the axial piston sealing ring 298 with respect to the axial piston 258 and subsequently
into the space 294.

In contrast, if a lower pressure prevails in the pressure space 266 than in the space 294, because the axial piston 258 is presently engaged or because said axial piston 258 is holding the bypass clutch open, then the axial piston sealing ring 298 bears against that inner wall 271 of the receiving groove 290 which is situated opposite the above-mentioned wall 270. Accordingly, the hydraulic fluid passes: from the space 294
through the clearance fit of the piston 258 with respect to the plate carrier 257,
the axial play of the axial piston sealing ring 298 with respect to the axial piston 258,
along the inner radial play of the axial piston sealing ring 298 with respect to the axial piston 258,

so that the axial piston sealing ring 298 is pressed against the inner wall 271 and an outer wall 290 and seals off at the sealing face which is thereby generated.

FIG. 8 shows an alternative embodiment to FIG. 1 or FIG. 2, in which a non-return valve 350 is used. Here, the defined throttle bore 317 is arranged in the axial piston 359 at the side of the pressure space 366, with said throttle bore 317 opening out into a larger bore in the axial piston 359, which larger bore has a sealing cone 369 and a ball 368. The ball is prevented from falling out by means of a non-uniformly encircling narrowing area 370 at the end of the large bore at the side of the space 394. If a pressure now acts in the pressure space 366, then the ball 368 bears against the non-uniform narrowing area 370, which permits a throughflow of the hydraulic fluid. If, in contrast, a lower pressure prevails in the pressure space 366 than in the space 394, because the axial piston 358 is presently engaged or because said axial piston 358 is holding the bypass clutch open, then the ball 368 bears, corresponding to FIG. 8, against the precisely machined sealing cone 369, so that the flow of hydraulic fluid into the pressure space 366 is prevented.

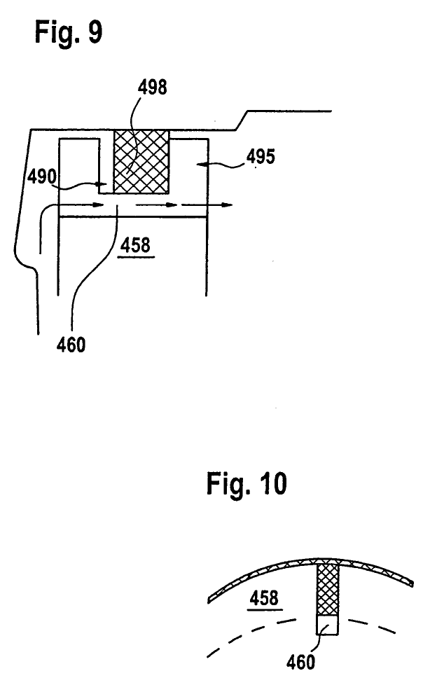

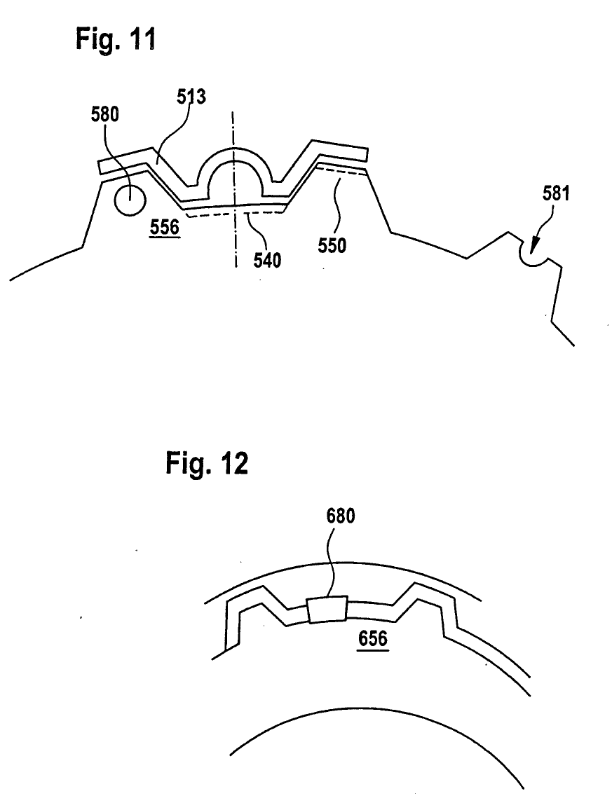

FIG. 9 and FIG. 10 show, in a further alternative embodiment, one possibility for producing the targeted leakage. Here, the axial piston 458 is provided with slots 495 which are situated in a radially outer region of the piston 458. Here, the slots 495 are milled continuously through the axial piston 458 in the direction of the central axis 25. That is to say that the slots 495 extend perpendicular to the receiving groove 490 of the axial piston sealing ring 498. Here, the slots 495 have a radially deeper base than the axial piston sealing ring 498, so that a flow of the hydraulic fluid through a region 460 situated radially within the axial piston sealing ring 498 is permitted.

FIG. 11 shows alternative measures to the additional oil throughflow recess 96 as per FIG. 3. There is thus the possibility, illustrated by means of dashed lines, of designing the tip circle diameter 550 and/or the root circle diameter 540 of the outer clutch plates 556 to be relatively small in order to produce a low flow resistance for the hydraulic fluid between the tip circle diameter 550 or the root circle diameter 540 and the plate carrier 513. This ensures that sufficient hydraulic fluid flows even in the rearmost gap between the clutch plates 55 and the thrust bearing disk 63. There is also the possibility, for this purpose, of providing the teeth of the outer clutch plates with recesses. Said recesses can for example be designed as bore holes 580 or as cutout grooves 581.

FIG. 12 likewise shows alternative measures to the additional oil throughflow recess 96 as per FIG. 3. There is thus the possibility of providing a plurality of peripherally distributed spacers 680 between the plate carrier 613 and the clutch plates 656, which spacers prevent the clutch plates opening an undefined gap with respect to the plate carrier. The effect described above with regard to FIG. 11 is thereby likewise obtained.

In order to close the bypass clutch in a softer and more comfortable manner, it can be provided in an alternative embodiment of the invention that the axial piston is supported radially at the outside by means of a plate spring directly or indirectly on the clutch plates, with direct support being illustrated throughout in DE 102 33 335 A1.

In an alternative embodiment, it is possible to provide a sealing ring on the sealing face 99 between the axial piston and the adjacent clutch plates.

In another alternative embodiment to FIG. 1 and FIG. 2, it is possible for the axial piston to be connected in a rotationally fixed manner to the outer clutch plates which are adjacent to it. For this purpose, the axial piston can be coupled to the outer clutch plate 67 indirectly by means of the plate carrier or directly. A single-part or pressed or calked connection between the axial piston and the clutch plates brings with it the advantage that, even when a high level of sealing is required, it is possible to dispense with the sealing ring mentioned in the above paragraph. In this embodiment, the axial guidance of the piston can also take place by means of the internal toothing 13 of the plate carrier.

The described embodiments are merely exemplary embodiments. A combination of the described features for different embodiments is likewise possible. Further features of the device parts pertaining to the invention can be gathered from the geometries of the arrangements as illustrated in the drawings.

What is claimed is:

1. A hydrodynamic torque converter (1) including a housing (5) with a torsion damper (7) and a bypass clutch (8) with clutch plates (55, 56), an axial piston (58) arranged adjacent the bypass clutch (8) for engaging the clutch plates (55, 56), said axial piston (58), together with the converter housing (5), enclosing a pressure space (66) which can be filled with hydraulic fluid under pressure for engaging said bypass clutch (58), and means for guiding said hydraulic fluid along the clutch plates (55, 56) to the torsion damper (7).

2. The hydrodynamic torque converter as claimed in claim 1, wherein the torsion damper (7) includes at least two peripherally distributed curved coil compression springs (14).

3. The hydrodynamic torque converter as claimed in claim 2, wherein each of the coil compression springs (14) includes an outer coil spring and arranged within the outer coil spring of the coil compression spring (14), an inner coil compression spring (47).

4. The hydrodynamic torque converter as claimed in claim 1, wherein the clutch plates (55, 56) have a groove pattern which enhances the guiding of the hydraulic fluid between the clutch plates (55, 56) radially inwardly.

5. The hydrodynamic torque converter as claimed in claim 1, wherein the hydraulic fluid is guided from a radially outer region of the piston (58), into a pressure space (94) which is delimited by the radially outer end of the axial piston (58), with the hydraulic fluid being conducted from said pressure space (94) at least partially through gaps between a shaft-hub toothing which is formed by a plate carrier (57) and the radially outer ends of the clutch plates (56), with the hydraulic fluid being distributed from there between the outer and inner clutch plates (56, 55).

6. The hydrodynamic torque converter as claimed in claim 5, wherein the hydraulic fluid emerges into the space (94) radially outside a sealing face (99) which is situated axially between the axial piston (58) and an outer clutch plate (56) which is disposed radially adjacent said axial piston (58).

7. The hydrodynamic torque converter as claimed in claim 1, wherein the axial piston (58) is sealed off with respect to the plate carrier (57) by means of a sealing ring (98) such that a defined leakage rate is maintained.

8. The hydrodynamic torque converter as claimed in claim 7, wherein the sealing ring (298) forms a non-return valve.

9. The hydrodynamic torque converter as claimed in claim 5, wherein the gaps in the shaft-hub toothing have varying dimensions.

10. The hydrodynamic torque converter as claimed in claim 1, wherein, for the defined supply with hydraulic fluid, spacers (680) are distributed peripherally at the shaft-hub connection between the plate carrier and the radially outer clutch plates (656).

11. The hydrodynamic torque converter as claimed in claim 1, wherein the bypass clutch has outer clutch plates (67, 63) which are guided within an outer plate carrier (57) which is welded to the housing (5) of the torque converter (1), with the outer plate carrier (57) and the clutch plates (67, 56, 63) being arranged radially within the area of the housing (5) where the screw connection (19) of the torque converter (1) to a driver disk (2) is located on the outside of the torque converter housing (5).

12. The hydrodynamic torque converter as claimed in claim 11, wherein an annularly extending axial recess (20) is provided in the turbine shell between the turbine wheel (37) and the freewheel (39), in which recess (20) the curved springs (47, 14) of the torsion damper (7) are partially accommodated, with the clutch plates (67, 55, 56) being situated axially adjacent to said torsion damper (7).
